(19) United States
(12) Patent Application Publication
(10) Pub. No.: US 2022/0236555 A1
(43) Pub. Date: Jul. 28, 2022

(54) LOUPES HAVING FEATURES ADAPTED FOR VARIOUS PROCEDURES

(71) Applicant: Trieu TON, Brentwood, CA (US)

(72) Inventor: Trieu TON, Brentwood, CA (US)

(21) Appl. No.: 17/570,689

(22) Filed: Jan. 7, 2022

Related U.S. Application Data
(60) Provisional application No. 63/142,120, filed on Jan. 27, 2021.

(51) Int. Cl. G02B 25/00

(52) U.S. Cl. CPC G02B 25/004; G02B 25/005; G02B 25/007

(57) ABSTRACT

Lenses are adapted to be attached to existing eyewear or provided as a separate pair of loupes. In an embodiment, different types of lenses are adapted to have zoom features. In an embodiment, prisms are provided that are non-symmetrical Schmidt roof prisms adapted to increase the deflection degree.

### BACKGROUND

This application claims the benefit of U.S. Provisional Application Ser. No. 63/142,120, filed Jan. 27, 2021, the contents of which are incorporated herein by reference.

### 1. Field

This application is directed to the field of loupes for providing improved viewing. In particular, the application is directed to various loupes and eyewear configurations that are adapted to improve viewing.

### 2. Description of the Related Art

Surgeons, dentists, and hygienists, among other professionals, use loupes to magnify the area where they perform their work. Some loupes fail to provide the best viewing conditions and/or require positioning oneself in a manner that is uncomfortable for extended periods of time. Therefore, there is a need in the field to improve and provide features to loupes to enable better viewing conditions for loupes.

### SUMMARY

Briefly described, aspects of the present disclosure relate to loupes. An aspect of the present disclosure is a set of loupes. The set of loupes comprising at least one prism; at least one housing adapted to house a lens arrangement and the at least one prism, the housing having an objective end and an ocular end, wherein light entering through the objective end is observable by a user viewing through the ocular end; and wherein the at least one prism is shaped and positioned within the housing so that a path of a ray of light passing through the objective end into the at least one prism is not symmetrical within the at least one prism before the ray of light passes through the ocular end.

Another aspect of the present disclosure is a set of loupes. The set of loupes comprising a first and a second housing, each of the first and second housings adapted to house a lens arrangement and a Schmidt roof prism, each of the first and second housings having an objective end and an ocular end, wherein light entering through the objective end is observable by a user viewing through the ocular end; and wherein the Schmidt roof prism is positioned so that a path of a ray of light passing through the objective end into the Schmidt roof prism is not symmetrical within the Schmidt roof prism before is passes through the ocular end.

### BRIEF DESCRIPTION OF THE DRAWINGS

The foregoing and other objects, features, and advantages of the disclosure will be apparent from the following more particular description of embodiments as illustrated in the accompanying drawings, in which reference characters refer to the same parts throughout the various views. The drawings are not necessarily to scale, emphasis instead being placed upon illustrating principles of the disclosed embodiments.

FIG. 1 is a side view of a set of loupes.

FIG. 2 is side view of set of loupes in a raised position

FIG. 3 is a view of a central portion of the set of loupes

FIG. 4 is a top-down view of set of loupes.

FIG. 5 is a front view of the set of loupes.

FIG. 6 a view of the set of loupes worn on a person.

FIG. 7 is a side view of a set of loupes worn on a person.

FIG. 8 is a view of a set of loupes with a light attached to the loupes

FIG. 9 shows the housing of a set of loupes.

FIG. 10 shows the interior lens arrangement of a set of loupes.

FIG. 11 shows the lens arrangement of a set of loupes and the ray path through the lens arrangement.

FIG. 12 shows a 3D view of the prism used in the lens arrangement.

FIG. 13 shows another lens arrangement of a set of loupes and the ray path through the lens arrangement.

FIG. 14 shows another lens arrangement of a set of loupes and the ray path through the lens arrangement.

FIG. 15 shows loupes attachable to glasses.

FIG. 16 shows another view of loupes attachable to glasses.

FIG. 17 shows a view of loupes with a knob for attaching a mask.

### DETAILED DESCRIPTION

To facilitate an understanding of embodiments, principles, and features of the present disclosure, they are disclosed hereinafter with reference to implementation in illustrative embodiments. Embodiments of the present disclosure, however, are not limited to use in the described systems or methods and may be utilized in other systems and methods as will be understood by those skilled in the art familiar with this disclosure.

Aspects of the present invention may apply principles related to surgical loupes disclosed in Applicant's U.S. Pat. No. 10,247,965 and U.S. patent application Ser. No. 16/663,643, the contents of both the patent and the application are incorporated herein by reference.

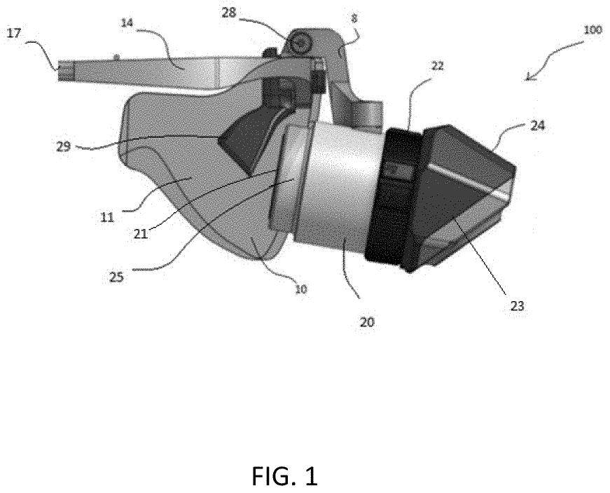

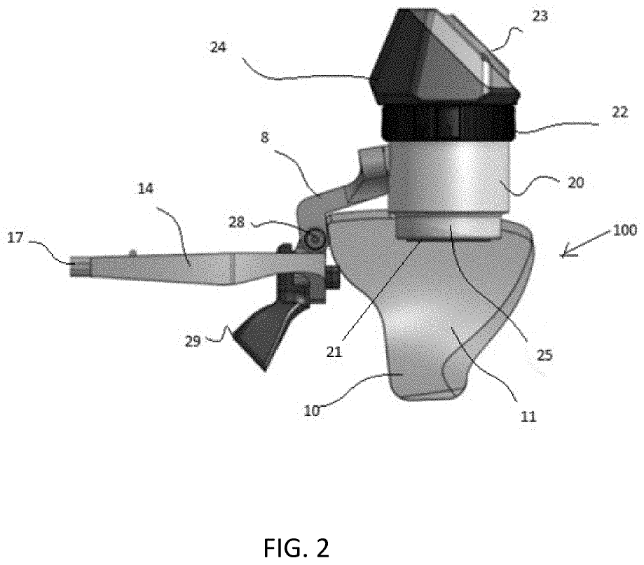

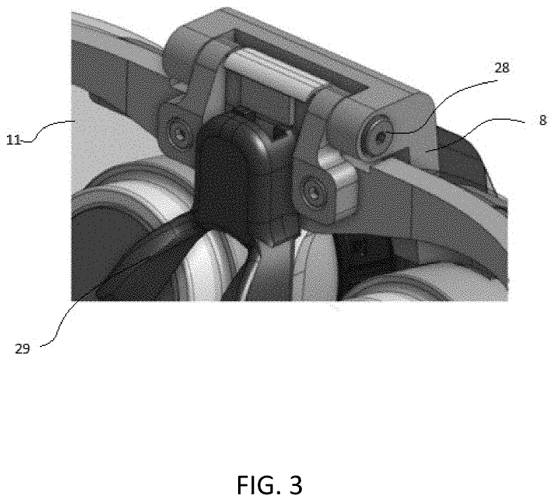

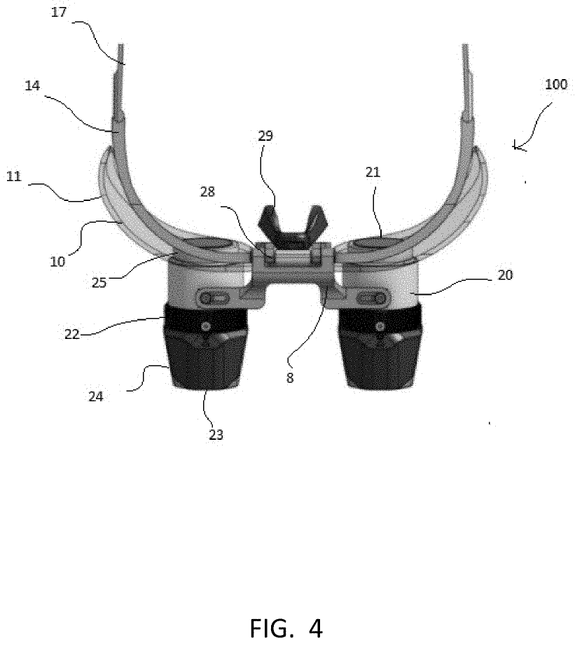

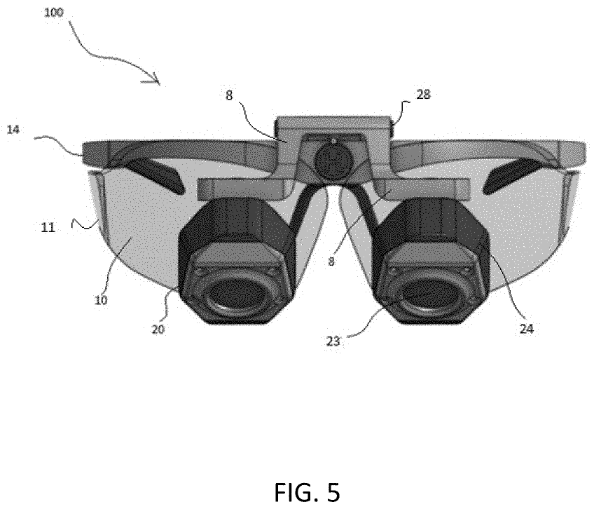

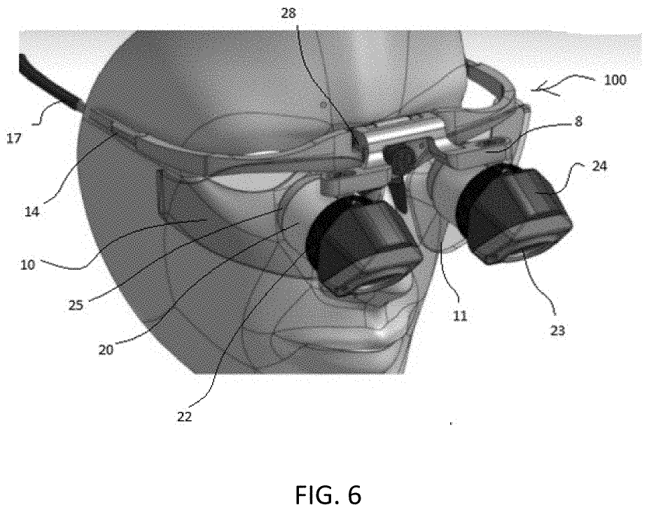

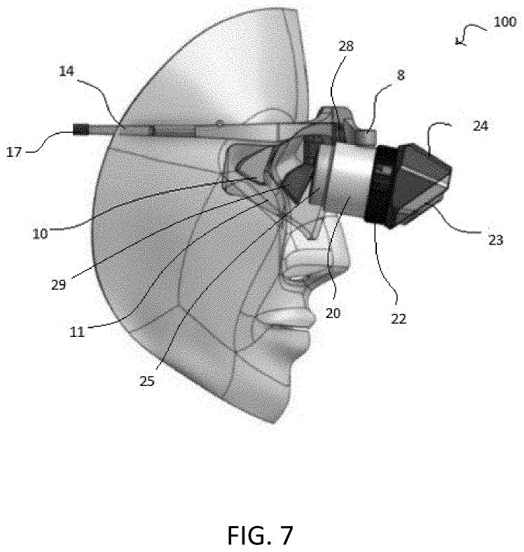

Turning now to the drawings, wherein embodiments of the loupes and items associated with it are shown, FIGS. 1-7 show loupes 100 made in accordance with an embodiment of the invention. FIG. 1 shows a side view of set of loupes 100. FIG. 2 shows a view of the set of loupes 100 when the housings 20 is and the eye protection portion 11 are raised. FIG. 3 is a view of the central portion of the set of loupes 100. FIG. 4 is a top-down view of the set of loupes 100. FIG. 5 is a front view of the set of loupes 100. FIG. 6 a view of the set of loupes 100 worn on a person. FIG. 7 is a side view of the set of loupes 100 worn on a person.

Loupes 100 are adapted to be worn by an individual who is engaged in a procedure that requires viewing certain regions close-up. The loupes 100 disclosed may be used by surgeons, dentists, and other individuals that work within the field.

The loupes 100 shown in FIGS. 1-7 comprise a housing 20 and an eyewear portion 10. In some embodiments, the set of loupes only comprise housing portions and are adapted to be secured to existing eyewear.

The eyewear portion 10 of the loupes comprises, eye protection portion 11, frames 14, ear hooks 17, spring hinge 28, and nose bridge 29. A connecting portion 8 connects the eyewear portion 10 to the housings 20 and enables the movement of the housings 20 and the eyewear portion 10.

Eye protection portion 11 may be formed from polycarbonate (PC) lenses that have been coated with anti-blue light and anti-fog. In an embodiment, the eye protection portion is formed from other plastic material. In an embodiment, the eye protection portion is formed form glass material.

The eye protection portion 11 formed from PC lens is mounted onto the housings 20 of the loupes 100 yet still can be flipped up as a whole unit due to the connecting portion 8 and the spring hinge 28. This is unlike traditional through the lens (TTL) loupes that do not have a flip up mechanism. Having the flip-up capability allows the ocular ends 25 to be closer to the person's eyes which is the benefit of the traditional through the lens, yet still have the flip up capability which can be lifted-up and out of the way. Because the pupillary distance can be adjusted to any user, one size for the set of loupes 100 is able to fit most individuals. In the embodiment, the eye protection portion 11 allows the user to protect theft eyes with sufficient medial and lateral coverage around each housing 20 as it expands or constricts according to the preferences and dimensions of each user.

The frames 14 are adapted to hold the loupes 100 on an individual's head when in use. The frames 14 are operably attached to the connecting portion 8 via the spring hinge 28. Nose bridge 29 is connected to the frame 14 and provides support for a user when the loupes 100 are being worn. The height of the nose bridge 14 is adjustable to accommodate the use of the loupes 100.

Frames 14 additionally are adjustable to change the length of the temple covering. This allows for the ear hooks 17 to be secured firmly to the ears to keep the frames 14 properly mounted to a user's face, such as with respect to the nose bridge 29. This prevents the frames 14 from falling forward. As discussed further below, the frames 14 additionally incorporate knobs for masks to reduce components needed for the loupes 100.

Each of the housings 20 of the loupes 100 comprises objective end 24, objective lens 23, ocular end 25 and ocular lens 21. The housing 20 also has focal cam 22.

The ocular end 25 passes through and is operably connected to the eye protection portion 11. In an embodiment, the housing 20 is secured to the eye protection portion 11 with an adhesive. In an embodiment, the housing 20 is secured to the eye protection portion 11 by integrally bonding the eye protection portion 11 to the housing 20.

The ocular end 25 houses the ocular lens 21. The objective end 24 is located distally from the ocular end 25. The objective end 24 houses the objective lens 23.

The focal cam 22 is located between the objective end 24 and the ocular end 25. Movement of the focal cam 22 will adjust the focus of the loupes 100 and permit the loupes 100 to change the magnification. In this way a user can change the focus and zoom in or out depending on the situation. The focal cam 22 allows the group of lenses located within the housing 10 to move and alter the magnification from between 2× to 6× magnification. In an embodiment, the magnification can be changed from between 1× to 10×.

Referring to FIG. 3, FIG. 3 is a view of the central portion of the loupes 100. FIG. 3 shows a view of the connecting portion 8, which has located therein a spring hinge 28. Connecting portion 8 is further connected to each of the housings 20, with one arm of the connecting portion 8 connected to either the left or right housing 20 and the other arm connected to the other one of the left or right housing 20.

Further shown is nose bridge 29. The nose bridge 29 allows the person to adjust the pupillary distance as needed by sliding the housings 20 together or outward. The spring hinge 28 is adapted to click into place when moved to an up position or down position (in-use), eliminating any loose screws. The spring hinge 28 permits rotation upwards. In an embodiment, other hinges are used to permit movement of the loupes 100 into different positions.

Loupes 100 differs from other products where eye protection portions stay stationary on the eyewear frame and do not allow the loupes to come close to the user's eyes. This design allows the housing 20 of the loupes 100 disclosed herein to be close to the user's eyes and yet provide protection around each eye. Traditional flip down loupes have eyewear lenses in the way and cannot approach closely to the user's eyes. Loupes 100 allow the ocular end 25 of the housing 20 of the loupes 100 to be mounted through the eye protective portion 11 yet remain stationary.

In an embodiment, the set of loupes rotates the view, so the two views converge at the working site. Fine tuning the view so it better fits the user. This helps eliminate re-calibration and re-mounting issues because they are fixed and are not adjustable once they are mounted. In an embodiment, there is a rotatable scope at the objective end to allow the person to change working distance and focus, so it better fits the person's preference.

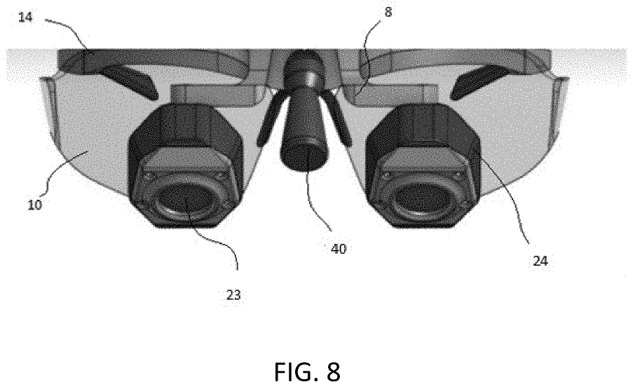

Now turning to FIG. 8, FIG. 8 is a view of loupes with a light 40 attached to the loupes. In an embodiment, there are more than one light 40 attached to the loupes. In an embodiment, the light, or lights 40 are motion sensor activated. The motion sensor permits activation of the light without requiring use of hands. In an embodiment, the light, or lights 40 are LEDs (light emitting diodes) adapted to create a shadow free area.

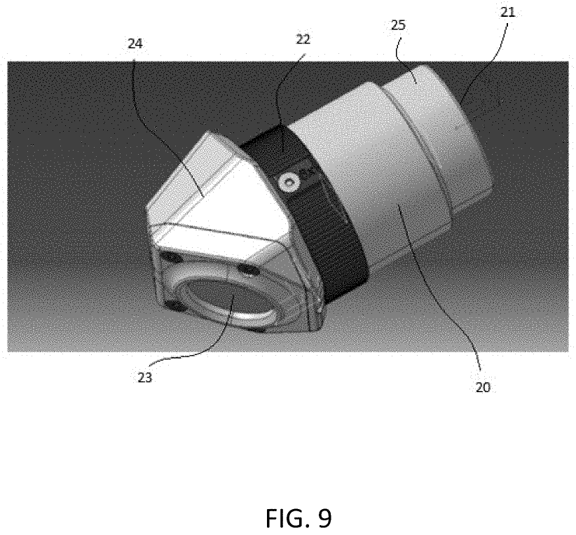

FIG. 9 shows the housing 20 of the loupes 100. The housing 20 of the loupes 100 comprises objective end 24, objective lens 23, ocular end 25 and ocular lens 21. The housing portion 20 also has focal cam 22. The ocular end 25 houses the ocular lens 21. The objective end 24 is located distally from the ocular end 25. The objective end 24 houses the objective lens 23.

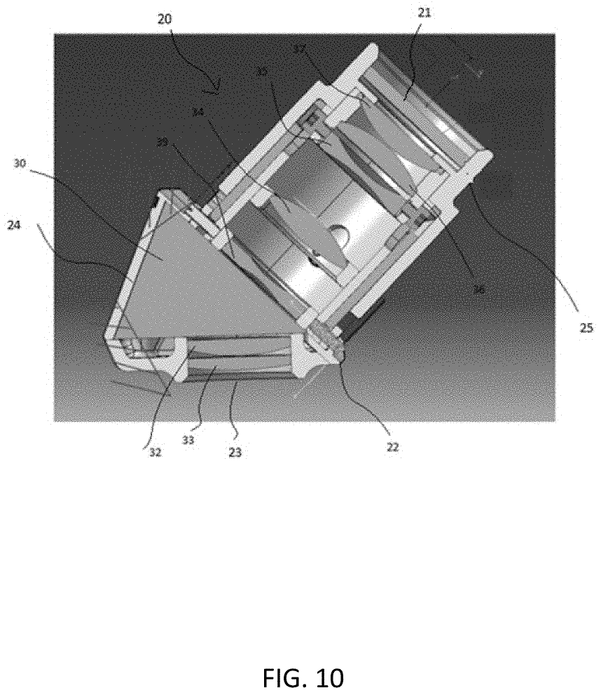

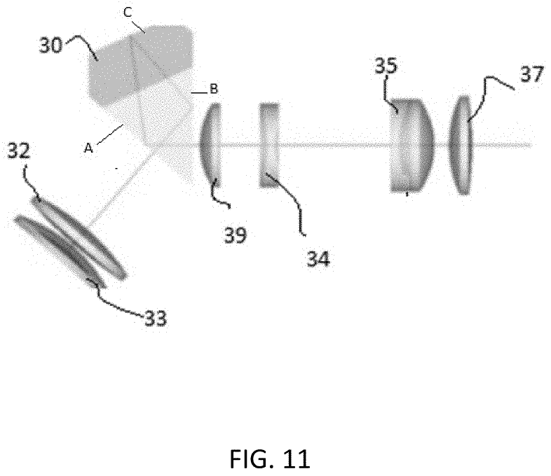

The focal cam 22 is located between the objective end 24 and the ocular end 25. Movement of the focal cam 22 will adjust the focus of the loupes 100 and permit the loupes 100 to change magnification. The focal cam 22 allows the group of lenses located within the housing 10, shown in FIGS. 10 and 11 to move and alter the magnification from between 2× to 6× magnification. In an embodiment, the magnification can be change from between 1× to 10×.

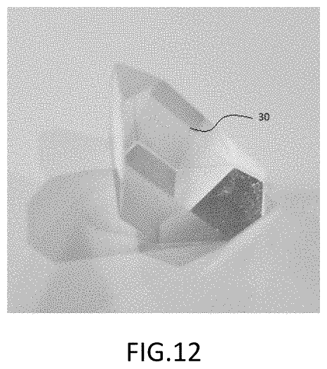

FIG. 10 shows the interior lens arrangement of set of loupes. FIG. 11 shows the lens arrangement of a set of loupes and the ray path through the lens arrangement. The lens arrangement shown in FIG. 11 is for a set of loupes having 8× magnification. FIG. 12 shows a 3D view of the prism 30 used in the lens arrangements shown in FIGS. 11 and 12.

A user looks through the ocular lens 21, which visualizes objects seen through the objective lens 23. Located within the interior of the of the housing 20 is series of lenses that control the path of light entering through the objective lens 23.

Light passes through the objective lens 23 and through first interior objective lens 33, which is a negative meniscus lens. The negative meniscus lens is a convex lens oriented with the convex side facing the prism 30. The light then passes through the second interior objective lens 32, which is a double-convex lens. Light then passes through the prism 30.

After the light passes through the prism 30, the light passes through the focal lens 39, which is a positive meniscus lens. The positive meniscus lens has its convex side facing the prism 30. In an embodiment, the focal lens 39 is operably connected to the focal cam 22 and can adjust the magnification of the image viewed at the ocular end 25. Light passes from the focal lens 39 through first interior housing lens 34, which is double concave lens, then through first interior ocular lens 35, which is a cemented double lens.

After passing through the first interior ocular lens 35 and, the light passes through the second interior ocular lens 37, which in an embodiment is a double-convex lens. Both the first interior ocular lens 35 and the second interior ocular lens 37 are convex lenses where the convex ends of each face each other.

Referring to FIG. 11, the line shown in the diagram illustrates the path of light through the lenses. As shown in FIG. 11, the path of light through the prism 30 is not symmetrical. That is to say, the path of the light is such that, it enters through side A, reflects off the interior of side B then reflects off the interior of side C, then off the interior of side A. When the light reflects off the interior of side A it does so at an area separate from where the light enters through side A. The resulting path inside the prism 30 is asymmetrical and forms a four-sided path having path lengths that are each of different length. This results in deflection that can be between 45-49 degrees.

In an embodiment, the 3D shape of the prism 30 is not symmetrical and in an embodiment, is a non-symmetrical Schmidt roof prism, as shown in FIG. 12.

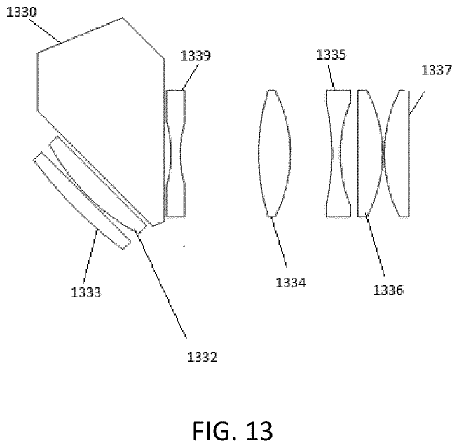

Turning to FIG. 13, FIG. 13 shows another embodiment of a lens layout for a set of loupes. This arrangement is generally for a 4-5-6× zoom design. Light passes through the objective lens on the set of loupes and through first interior objective lens 1333, which is a plano-convex lex. The plano-convex lens is a convex lens oriented with the convex side facing away from the prism 1330. The light then passes through the second interior objective lens 1332, which is a plano-convex lens with the convex side facing away from the prism 1330. Light then passes through the prism 1330. The prism 1330 is a roofed Schmidt prism.

After the light passes through the prism 1330, the light passes through the focal lens 1339, which is a symmetrical double-concave lens. In an embodiment, the focal lens 1339 is operably connected to the focal cam and can adjust the magnification of the image viewed at the ocular end 1325. Light passes from the focal lens 1339 through first interior housing lens 1334, which is double convex lens, then through second interior housing lens 1335, which is a double-concave lens and first interior ocular lens 1336, which is a plano-convex lens.

After passing through the second interior housing lens 1335 and through first interior ocular lens 1336, the light passes through the second interior ocular lens 1337, which in an embodiment is plano-convex lens. Both the first interior ocular lens 1336 and the second interior ocular lens 1337 are convex lenses where the convex ends of each face each other.

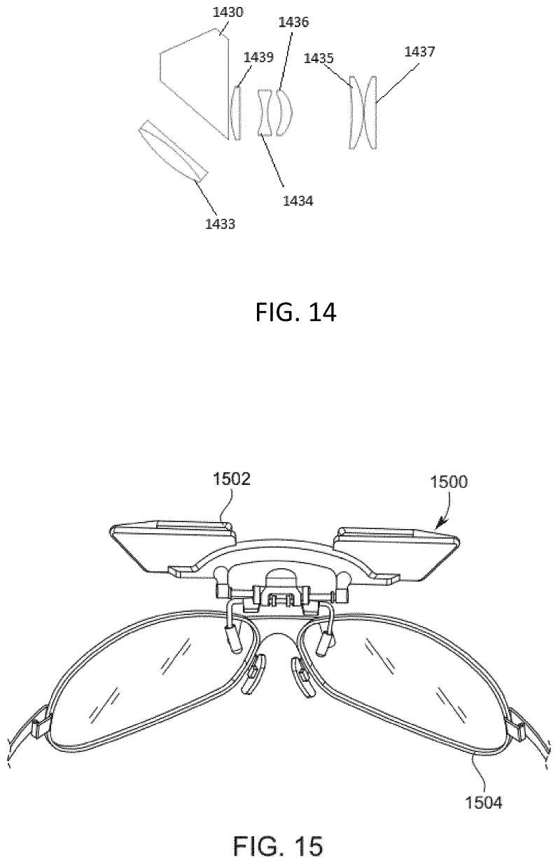

Turning to FIG. 14, FIG. 14 shows another embodiment of a lens layout for a set of loupes. The lens layout shown provides a 5× zoom design. Light passes through the objective lens and through first interior objective lens 1433, which is a cemented doublet lens. The light then passes Light then passes through the prism 30. The prism is a 49-degree Schmidt prism with roof.

After the light passes through the prism 30, the light passes through the focal lens 1439, which is a plano-convex lens with the convex side facing the prism 30. In an embodiment, the focal lens 1439 is operably connected to the focal cam and can adjust the magnification of the image viewed at the ocular end. Light passes from the focal lens 1339 through first interior housing lens 1334, which is double concave lens, then through second interior housing lens 1436, which is a positive meniscus lens.

After passing through the second interior housing lens 1436, the light will pass through the first interior ocular lens 1435, which is a positive meniscus lens. After the light passes through the first interior ocular lens 1435 the light passes through the second interior ocular lens 1437, which in an embodiment is a plano-convex lens. Both the first interior ocular lens 1435 and the second interior ocular lens 1437 are convex lenses where the convex ends of each face each other.

In an embodiment, mirrored Littrow prisms are used in the loupes to achieve the viewing results. In an embodiment, Schmidt roof prisms are used in the loupes to achieve viewing results. In an embodiment, Amici prisms are used in the loupes to achieve viewing results.

In an embodiment, when mirrored Littrow prisms are used, the mirrored Littrow prism loupes have a panoramic shape. By panoramic shape it is meant that the prism has a rectangular shape near the ocular end of the loupes that then expands outwardly. In an embodiment, each objective lens has a larger width than the lens at the ocular end of the loupes.

In an embodiment, the prism used is narrower near the ocular end than at the objective end, which is located opposite of the ocular end. The shape of this prism for the loupes provides a panoramic view for the user and fits many users' pupillary distance since the ocular shape of the lens that is employed is rectangular.

In an embodiment, the set of loupes are zoom enabled. In an embodiment, the zoom enabled prism lenses have cam mechanisms that allow the group of lenses to move within the loupes to zoom from between 2× to 6× magnification. In an embodiment, the zoom enabled prism lenses have cam mechanisms that allow the group of lenses to move within the loupes to zoom from between 2× to 8× magnification. In an embodiment, the loupes can zoom from between 1× to 10×.

In an embodiment, the set of loupes have a prism near the objective end of the lens. In an embodiment, the prism is a Schmidt roof prism adapted to deflect the image 45 degrees. In an embodiment, the prism is a Schmidt roof prism adapted to deflect the image 45-49 degrees. In an embodiment, the prism is a mirrored Littrow prism adapted to deflect the image 60 degrees. In an embodiment, the prism is a mirrored Littrow prism adapted to deflect the image more than 60 degrees. In an embodiment, the prism is a mirrored Littrow prism adapted to deflect the image between 60-85 degrees.

In an embodiment, the prism is a modified Amici prism that has equilateral sides and a 60-degree, internal angle that is adapted to deflect the image 60 degrees. This type of prism is different than other Amici prisms in that other Amici prisms are adapted to only provide 45 degrees of deflection. In some embodiments, the prisms are Amici prisms that are modified to deflect the view between 45 degrees to 60 degrees. In some embodiments, the prisms are Amici prisms that are modified to deflect view above 45 degrees.

In an embodiment, the Schmidt roof prism zoom enabled prism loupes can additionally be mounted at 10-15 degrees to achieve 60 degrees deflection since it deflects at least 45 degrees by itself. Once it is mounted to the prism loupes, it can gain an additional tilt from 5-15 degrees.

Lenses and the arrangement of lenses may be varied depending on the specific needs of the user. The lens arrangement can comprise a variety of concave, convex, and cemented lens depending on the needs of the user.

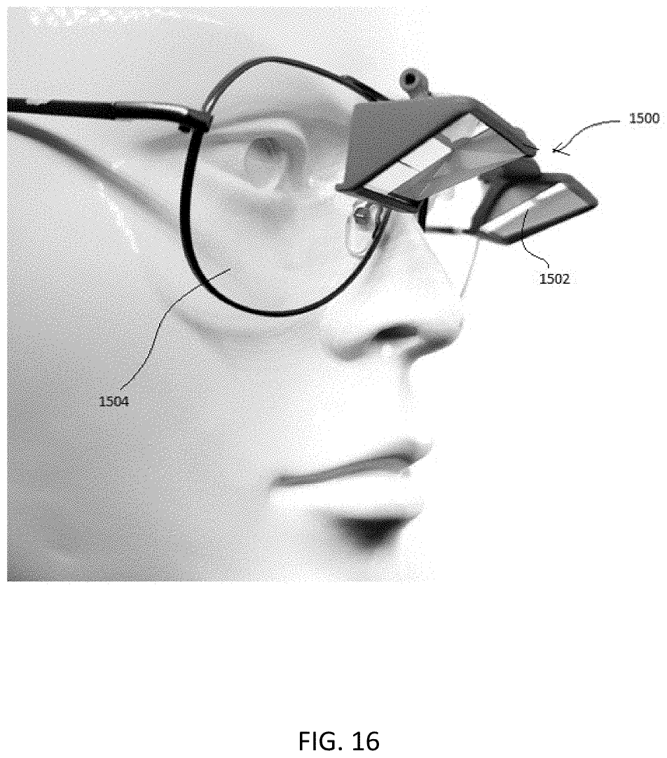

Turning to FIGS. 15 and 16, FIGS. 15 and 16 show loupes 1500 attachable to glasses 1504. Loupes 1500 have lenses 1502 that magnify the view. Loupes 1500 are adapted to have mirrored Littrow prisms that are used separately or placed over existing eyewear. The loupes 1500 may also have a Schmidt roof prism.

Once open on the objective side, the user can adjust the focus and working distance of the loupes 1500. Once the mirror coated Littrow prism is attached, the convergence angle can be adjusted, and a user can see 60 degrees below their eyelevel. The working distance and convergence angle can also be adjusted by the user. This view can be secured by a screw to stabilize position. Various magnifications, from between 2× and 10× can be obtained, such as 4× and 5× magnification. A light component can be attached for illumination. Additionally, an antireflective coating can be used to reduce glare. In an embodiment, lenses 1502 are trapezoidal in shape to increase field of view. In an embodiment, the housings for the loupes are attached to protective eyewear or prescription glasses. In an embodiment, the protective eyewear has a flip up mechanism, such as the flip up mechanism discussed above, to lock it in place when not in use. In an embodiment, the loupes are integrated with the protective eyewear.

In an embodiment, the mirrored Littrow prism is a separate addition to traditional loupes. In an embodiment, a mirrored Littrow prism is adapted to be attached to existing eyewear. In an embodiment, there is a housing that allows the prism lens to screw onto existing loupes. In an embodiment, there is a suction cup enabled lens that is adapted to be placed on the objective end of existing loupes. In an embodiment, the suction cup is made of rubber material. In an embodiment, there is a prism cap that permits different prisms to be screwed onto the ends of the loupes. In an embodiment, the attachable lens allows deflection of the image 60 degrees. In an embodiment, the attachable lens allows easy rotation to converge images when being viewed by a user.

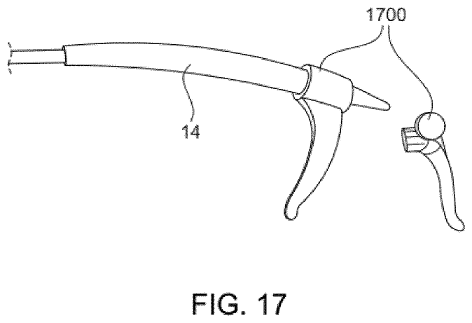

Turning to FIG. 17, FIG. 17 shows a view of frames 14 with a knob 1700 for attaching a mask. In an embodiment, ear fins or hooks made of silicone can be placed on the frames 14 to prevent the eyewear from slipping. In an embodiment, the hooks can hook around the back of the ears. In an embodiment, these fins/hooks are different because the fins/hooks have a knob 1700 that allows masks to be able to loop around the silicone to relieve pressure around the ear due to wearing masks.

In an embodiment, the knob 1700 is a circle shape. In an embodiment, the knob is a half-circle shape. In an embodiment, the knob is square shaped. In an embodiment, the knob is conical shaped. In an embodiment, the knob is spherical shaped. In an embodiment, the knob is rectangular shaped. In an embodiment, the knob is triangular shaped.

The knob 1700 allows a mask to loop around it easily. The fins/hooks on the frames 14 also counterbalance the weight of the set of loupes to alleviate weight on the ridge of the nose from eyewear

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A set of loupes comprising:
at least one prism;
at least one housing adapted to house a lens arrangement and the at least one prism, the housing having an objective end and an ocular end, wherein light entering through the objective end is observable by a user viewing through the ocular end; and
wherein the at least one prism is shaped and positioned within the housing so that a path of a ray of light passing through the objective end into the at least one prism is not symmetrical within the at least one prism before the ray of light passes through the ocular end.

2. The set of loupes of claim 1, wherein the at least one prism has a deflection degree of greater than 45 degrees and less than 90 degrees.

3. The set of loupes of claim 1, wherein the at least one prism has a deflection degree of greater than 45 degrees and less than 50 degrees.

4. The set of loupes of claim 1, wherein the at least one prism is Schmidt roof prism.

5. The set of loupes of claim 1, wherein the at least one prism is a Littrow prism.

6. The set of loupes of claim 1, wherein the set of loupes is adapted to be attached to existing eyewear.

7. The set of loupes of claim 1, wherein the at least one housing is adapted to rotate to converge a view from the ocular end of the at least one housing with a view from an ocular end of at least one other housing.

8. The set of loupes of claim 1, wherein the at least one housing has a cam system adapted to enlarge images viewed through the ocular end.

9. The set of loupes of claim 1, further comprising a hinged mechanism having a spring mechanism adapted to raise the at least one housing and at least one other housing when a user is not viewing through the ocular end.

10. The set of loupes of claim 1, further comprising a knob adapted to secure a mask to the set of loupes.

11. The set of loupes of claim 1, wherein the ocular end comprises a rectangular shaped lens.

12. The set of loupes of claim 11, wherein the rectangular shaped lens has a smaller width than a lens located at the objective end.

13. The set of loupes of claim 1, further comprising motion activated loupe lights, wherein the motion activated loupe lights are light emitting diodes.

14. A set of loupes comprising:
A first and a second housing, each of the first and second housings adapted to house a lens arrangement and a Schmidt roof prism, each of the first and second housings having an objective end and an ocular end, wherein light entering through the objective end is observable by a user viewing through the ocular end; and
wherein the Schmidt roof prism is positioned so that a path of a ray of light passing through the objective end into the Schmidt roof prism is not symmetrical within the Schmidt roof prism before is passes through the ocular end.

15. The set of loupes of claim 14, wherein the Schmidt roof prism has a deflection degree of greater than 45 degrees and less than 90 degrees.

16. The set of loupes of claim 14, wherein the Schmidt roof prism has a deflection degree of greater than 45 degrees and less than 50 degrees.

17. The set of loupes of claim 14, wherein the set of loupes is adapted to be attached to existing eyewear.

18. The set of loupes of claim 14, wherein the first and second housings are adapted to rotate to converge a view from the ocular end of at least one of the first and second housings with a view from an ocular end of at least another one of the first and second housings.

19. The set of loupes of claim 14, wherein the first and second housings each have a cam system adapted to enlarge images viewed through the ocular end of each of the first and second housings.

20. The set of loupes of claim 14, further comprising a knob adapted to secure a mask to the set of loupes.
